(19) United States
(12) Patent Application Publication
(10) Pub. No.: US 2010/0103457 A1
(43) Pub. Date: Apr. 29, 2010

(54) Image forming apparatus and print system

(75) Inventor: Takahiko Nakamura, Ibaraki-ken (JP)

Correspondence Address: THE NATH LAW GROUP, 112 South West Street, Alexandria, VA, 22314, US

(73) Assignee: RISO KAGAKU CORPORATION, Tokyo (JP)

(21) Appl. No.: 12/588,720

(22) Filed: Oct. 26, 2009

(30) Foreign Application Priority Data
Oct. 28, 2008 (JP) P2008-277173

(51) Int. Cl. G06F 15/00

(52) U.S. Cl. 358/1.15

(57) ABSTRACT

An image forming apparatus is connected to a plurality of networks including a network connected with an image processor and includes a storer for storing in memory a plurality of address sets each composed of a first kind address of the image forming apparatus and a first kind address of the image processor, and a communication controller to employ the plurality of address sets stored in memory of the storer, for a sequence of trials of connection with the image processor to determine a connectable address set to use for communications with the image processor, as the image processor is adapted for storage of a plurality of address sets each composed of a first kind address of the image processor and a first kind address of the image forming apparatus.

### BACKGROUND OF THE INVENTION

1. Field of the Invention

The present invention relates to an image forming apparatus, and a print system including an image forming apparatus, allowing for network connections simplified to set up.

2. Description of Related Arts

Japanese Patent Application Laid-Open Publication No. 2006-319644 has disclosed an image forming apparatus provided with a plurality of interfaces for communications with networked equipments. For network connections to be made of such an image forming apparatus, respective interfaces need to have their addresses individually set up.

Some types of image forming apparatuses have no parts to function as an RIP (raster image processor) for rasterizing a page description language such as PostScript. For connection of such a type of image forming apparatus to a LAN to thereby print a data described in a page description language, there should be provision of an RIP unit for rasterizing the data, and connection of the RIP unit to the image forming apparatus. Further, there are needs of having the data in page description language input via the LAN to the RIP unit, having a bit map data developed at the RIP unit and output to the image forming apparatus, and having the image forming apparatus make a print in accordance with the bit map data.

Accordingly, such a type of image forming apparatus needs to have an interface for direct printable data to be input thereto from a PC (personal computer) via a LAN, and another interface for raster data to be input thereto from the PC via an RIP unit. The RIP unit needs to have an interface for data in page description language to be input thereto from the PC via the LAN, and another interface for raster data to be output therefrom to the image forming apparatus.

### SUMMARY OF THE INVENTION

There is a protocol used for connection between the RIP unit and the image forming apparatus. For that protocol to be identical to a protocol for the LAN interconnecting the PC and the image forming apparatus, the interface for connection of this image forming apparatus with the RIP unit and the interface for connection of the RIP unit with the image forming apparatus should have their addresses each respectively different from address of interfaces the PC has for connection with the LAN. Further, each of those addresses should be different from an address of the interface for connection of the image forming apparatus with the LAN and an address of the interface for connection of the RIP unit with the LAN. In addition, for communications between the RIP unit and the image forming apparatus, the interfaces paired in between should each have an address of the opponent set therein. As a result, there has been a significant burden on a network manager serving to connect a combination of an image forming apparatus and an RIP unit to associated LANs.

It is an object of the present invention to provide an image forming apparatus, and a print system including an image forming apparatus, having a plurality of interfaces for connections through networks to an image processor, allowing for network connections simplified to set up.

To achieve the object described, according to a first aspect of the present invention, an image forming apparatus is connected to a plurality of networks including a network connected with an image processor and adapted for storage of a plurality of address sets each composed of a first kind address of the image processor and a first kind address of the image forming apparatus, the image forming apparatus comprising a storer configured to store in memory a plurality of address sets each composed of a first kind address of the image forming apparatus and a first kind address of the image processor, and a communication controller configured to employ the plurality of address sets stored in memory of the storer, for a sequence of trials of connection with the image processor to determine a connectable address set to use for communications with the image processor.

To achieve the object described, according to a second aspect of the present invention, a print system includes a combination of an image processor and an image former connected therewith through a network, the image former connected to a plurality of networks including the network, wherein the image processor comprises a storer configured to store in memory a plurality of address sets each composed of a first kind address of the image processor and a first kind address of the image former, and a setup acceptor configured to accept a selection of any address set of the plurality of address sets, and the image former comprises a storer configured to store in memory a plurality of address sets each composed of a first kind address of the image former and a first kind address of the image processor, and a communication controller configured to employ the plurality of address sets stored in memory of the storer of the image former, for a sequence of trials of connection with the image processor to determine a connectable address set to use for communications with the image processor.

### BRIEF DESCRIPTION OF DRAWINGS

FIG. 1 is a block diagram showing configuration of a networked print system according to an embodiment of the present invention.

FIG. 2 is a block diagram showing functional configuration of a combination of a printer and an RIP unit according to a first example of the embodiment.

FIG. 3 is a table listing examples of address sets stored at the printer end, and address sets stored at the RIP unit end.

FIG. 4 is an illustration of a setup acceptance frame provided by an IP setup acceptor of the printer.

FIG. 5 is an illustration of a setup acceptance frame provided by an IP setup acceptor of the RIP unit.

FIG. 6 is a block diagram showing functional configuration of a combination of a printer and an RIP unit according to a second example of the embodiment.

FIG. 7 is part of a flowchart of control actions in an automatic network setup process at the printer.

FIG. 8 is the rest of the flowchart.

### DETAILED DESCRIPTION OF EMBODIMENTS

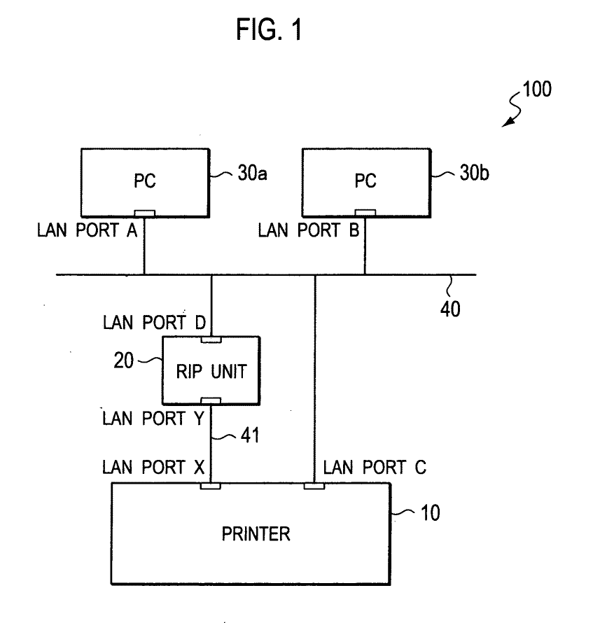

There will be described modes of embodiment of the present invention, with reference to drawings. FIG. 1 is a block diagram showing configuration of a networked print system according an embodiment of the present invention. As illustrated in the figure, there is a networked print system 100, which is configured with a printer 10 working as an image former and an RIP unit 20 working as an image processor, each respectively connected with a plurality of PCs 30 (i.e. a PC 30a, a PC 30b, . . . ) through a first network 40, while the RIP unit 20 is connected through a second network 41 to the printer 10. In typical applications, the first and second networks 40 and 41 may well be LANs composed of IP networks. The network 40 as well as the network 41 may be a LAN, WAN, or Internet composed of a TCP/IP network. In this embodiment, they are each made up as a LAN of TCP/IP network. In the IP network, each interface connected to the LAN is identified by an IP address. Accordingly, interfaces of associated equipments need to have different IP addresses.

The printer 10 is configured to make a print in accordance with a print data input thereto, the print data being formatted in a prescribed manner. In this respect, the printer 10 is not adapted to rasterize a page description language such as PostScript. The printer 10 has a LAN port C and a LAN port X as network interfaces. The LAN port C is a LAN port for connection to the first network 40, and has an IP address preset by a network manager. The LAN port X is a LAN port for connection to the RIP unit 20 through the second network 41, and will be given an IP address set up in a later-described manner.

The RIP unit 20 is an image processor adapted to rasterize a page description language such as PostScript, and has a LAN port D and a LAN port Y as network interfaces. The LAN port D is a LAN port for connection to the first network 40, and has an IP address preset by the network manager. The LAN port Y is a LAN port for connection to the printer 10 through the second network 41, and will be given an IP address set up in a later-described manner.

Each PC 30 has a LAN port as a network interface for connection to the first network 40, with an IP addresses preset by the network manager. Any PC 30 may be connected to the first network 40, with an IP address then determined dynamically.

In the networked print system 100, any PC, e.g., the PC 30a, is adapted to provide a normal print data that the printer 10 can interpret to make a print. This print data is output through the first network 40 to the LAN port C of printer 10. The printer 10 is adapted to make a print based on thus input data.

Further, each PC 30 is adapted to provide a print data described in a page description language such as PostScript that the printer 10 is unable to interpret to make a print. This print data is output through the first network 40 to the LAN port D of RIP unit 20. At the RIP unit 20, the print data in page description language is rasterized for conversion into a bit map data, which is output from the LAN port Y of RIP unit 20 to the LAN port X of printer 10. The printer 10 is adapted to make a print based on thus input data.

There will be described how to set up an IP address of LAN port X of printer 10, and an IP address of LAN port Y of RIP unit 20.

### First Embodiment Example

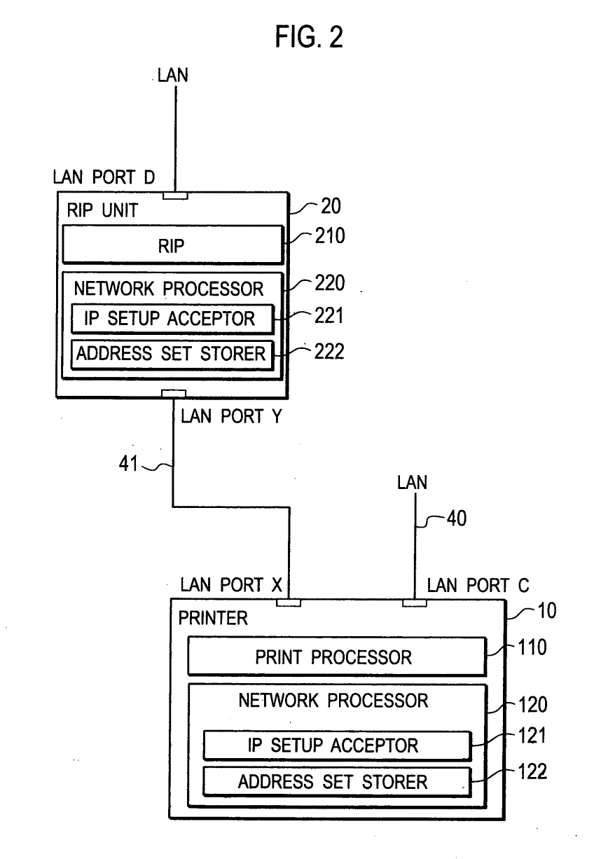

FIG. 2 is a block diagram showing functional configuration of a combination of a printer 10 and an RIP unit 20 according to a first embodiment example. As illustrated in the figure, the printer 10 includes a print processor 110 and a network processor 120. The print processor 110 is configured to implement a print process in accordance with a bit map data or a print data of a prescribed format.

The network processor 120 is configured to implement a set of network processes for communications through a LAN port C that is an interface to a first network 40, and a LAN port X that is an interface to a second network 41. In this embodiment example, the process set includes a process of setting up an IP address of the LAN port X. Hence, the network processor 120 includes an IP setup acceptor 121, and an address set storer 122. The IP setup acceptor 121 is configured to accept from network manager, through an operation panel (not shown) of the printer 10, a selection of an arbitrary one of address sets each composed of an IP address of the LAN port X and an IP address of a LAN port Y of the RIP unit 20 being a destination of communication. The address set storer 122 is configured to store a set of such the address sets in a nonvolatile memory.

The RIP unit 20 includes an RIP 210 as software, and a network processor 220. The RIP 210 is configured to implement a process of rasterizing a print data in page description language for conversion into a bit map data.

The network processor 220 is configured to implement a set of network processes for communications through a LAN port D that is an interface to the first network 40, and the LAN port Y that is an interface to the second network 41. In this embodiment example, the process set includes a process of setting up an IP address of the LAN port Y. Hence, the network processor 220 includes an IP setup acceptor 221, and an address set storer 222. The IP setup acceptor 221 is configured to accept from network manager, through an operation panel (not shown) of the RIP unit 20 or any locally connected equipment else, a selection of an arbitrary one of address sets each composed of an IP address of the LAN port Y and an IP address of the LAN port X being a destination of communication. The address set storer 222 is configured to store a set of such the address sets in a nonvolatile memory. This set of address sets is paired to that set of address sets stored in memory by the address set storer 122 at the network processor 120 of printer 10.

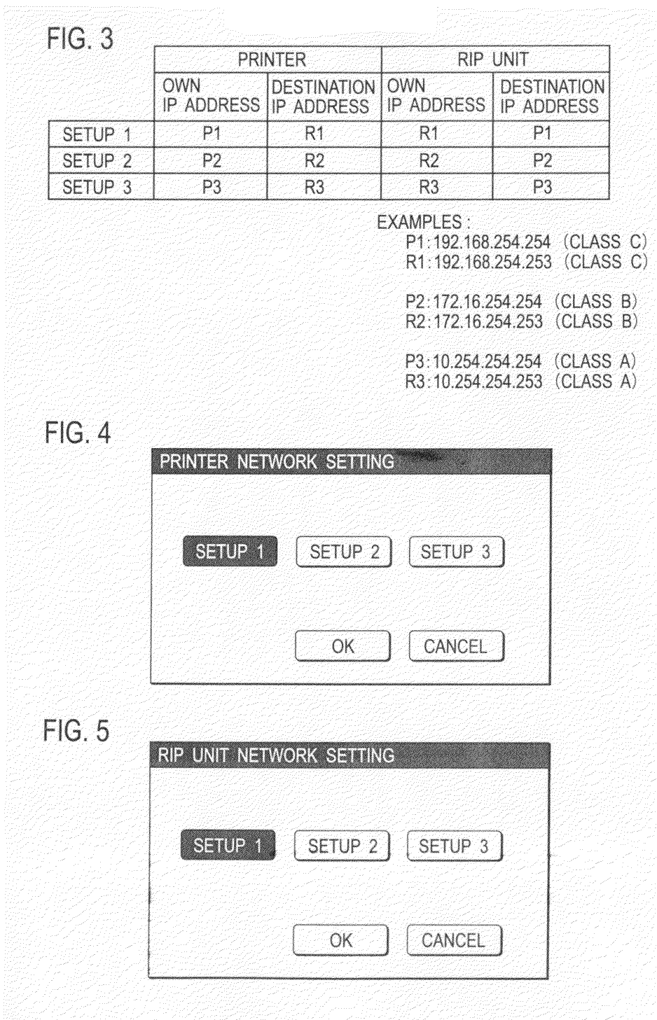

FIG. 3 illustrates an exemplary listing of address sets stored at the end of the printer 10, and address sets stored at the end of the RIP unit 20. In this table, there are three groups of address sets referred to as “setup 1”, “setup 2”, and “setup 3”.

The group “setup 1” has set up, at the printer 10 end, an address set consisting of: an IP address P1 (of the LAN port X) of its own; and an IP address R1 of the LAN port Y of RIP unit 20 being a destination of communication. On the other hand, at the RIP unit 20 end, it has set up an address set consisting of: the IP address R1 (of the LAN port Y) of its own; and the IP address P1 of the LAN port X of printer 10 being a destination of communication. That is, both printer 10 and RIP unit 20 have a set of address sets “setup 1” employed for mutual recognition in between, allowing for an established interconnection to make communications as necessary It is then assumed that all LAN ports connected to the LAN 40 have IP addresses set up to be different from P1 and R1.

The group “setup 2” has set up, at the printer 10 end, an address set consisting of: an IP address P2 (of the LAN port X) of its own; and an IP address R2 of the LAN port Y of RIP unit 20 being a destination of communication. On the other hand, at the RIP unit 20 end, it has set up an address set consisting of: the IP address R2 (of the LAN port Y) of its own; and the IP address P2 of the LAN port X of printer 10 being a destination of communication. That is, both printer 10 and RIP unit 20 have a set of address sets “setup 2” employed for mutual recognition in between, allowing for an established interconnection to make communications as necessary. It is then assumed that all LAN ports connected to the LAN 40 have IF addresses set up to be different from P2 and R2.

The group “setup 3” has set up, at the printer 10 end, an address set consisting of: an IP address P3 (of the LAN port X) of its own; and an IP address R3 of the LAN port Y of RIP unit 20 being a destination of communication. On the other hand, at the RIP unit 20 end, it has set up an address set consisting of: the IP address R3 (of the LAN port Y) of its own; and the IP address P3 of the LAN port X of printer 10 being a destination of communication. That is, both printer 10 and RIP unit 20 have a set of address sets “setup 3” employed for mutual recognition in between, allowing for an established interconnection to make communications as necessary. It is then assumed that all the other LAN ports connected to the LAN 40 have IP addresses set up to be different from P3 and R3.

It therefore is possible for a network manager to have an address set corresponding to an address set having been set up at the printer 10, set up at the RIP unit 20, allowing for an established interconnection between the printer 10 and the RIP unit 20. More specifically, it is possible to make a combination of a first selection to select e.g. “setup 1” on a setup acceptance frame illustrated in FIG. 4 as a frame provided by the IP setup acceptor 121 of the printer 10, and a second selection to select “setup 1” on a setup acceptance frame illustrated in FIG. 5 as a frame provided by the IP setup acceptor 221 of the RIP unit 20.

Preferably, as in FIG. 3, the addresses P1 and R1 to be designated by selection of “setup 1” should each be an IP address within a range of private IP addresses (192.168.0.0 to 192.168.255.255) in the Class C (192.0.0.0 to 223.255.255.255). For selection of “setup 2”, the addresses P2 and R2 to be designated should each be an IP address within a range of private IP addresses (172.16.0.0 to 172.31.255.255) in the Class B (128.0.0.0 to 191.255.255.255). Further, for selection of “setup 3”, the addresses P3 and R3 to be designated should each be an IP address within a range of private IP addresses (10.0.0.0˜10.255.255.255) in the Class A (0.0.0.0˜127.255.255.255). It is noted that network managers may designate addresses of any address set not simply by use of IP addresses of a Class as described, but also by addresses (e.g. subnet addresses, default gateway addresses, or such) taking a subnet mask, default gateway, or such into account, as necessary.

For setup of any address set, selecting a pair of addresses of a Class provides an ensured reduction of address duplication. For instance, for a network manager who has the first network 40 as a Class C under own management, it is possible to select one of “setup 2” and “setup 3” for interconnection between the printer 10 and the RIP unit 20 in the second network 41, with a reduced probability of duplication of an IP address set up at any LAN port else in the first network 40 in which PCs and the like have IP addresses of the Class C assigned thereto. Likewise, for a network manager who has the first network 40 as a Class B under own management, it is possible to select one of “setup 1” and “setup 3” for interconnection between the printer 10 and the RIP unit 20 in the second network 41, with a reduced probability of duplication of an IP address set up at any LAN port else in the first network 40 in which PCs and the like have IP addresses of the Class B assigned thereto.

Therefore, according to the first embodiment example, it is possible for a network manager to make up easily a network connection between printer 10, connected to a plurality of networks (first and second networks 40 and 41), and RIP unit 20 by simple selection of paired address sets as set up at the printer 10 and the RIP unit 20.

### Second Embodiment Example

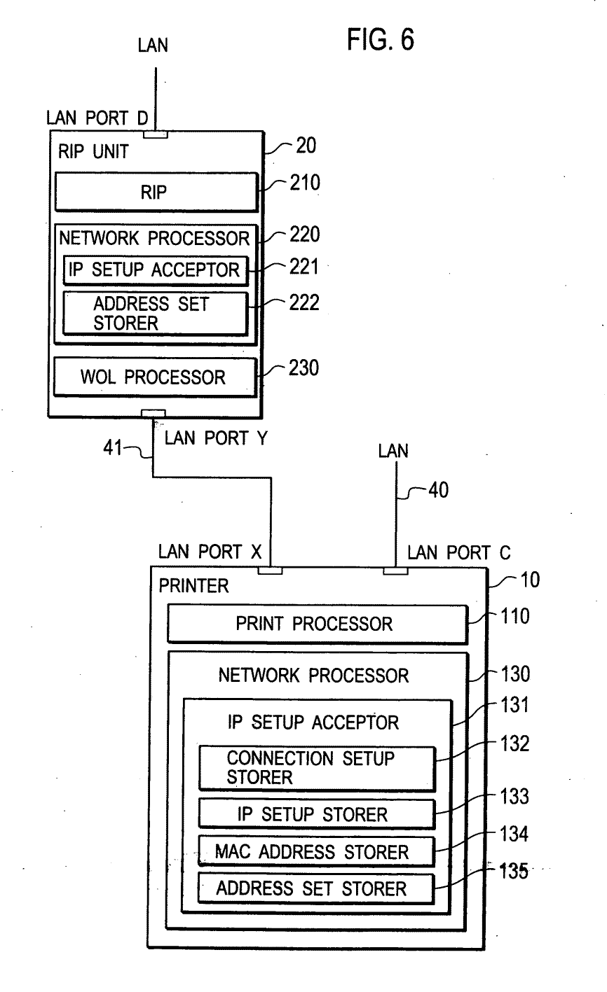

FIG. 6 is a block diagram showing functional configuration of a combination of a printer 10 and an RIP unit 20 according to a second embodiment example. Description of overlapping elements between the first and second embodiment examples will be simplified.

As illustrated in the figure, the printer 10 includes a print processor 110 and a network processor 130. The print processor 110 is configured to implement a print process in accordance with a bit map data or a print data of a prescribed format.

The network processor 130 is configured to implement a set of network processes for communications through a LAN port C that is an interface to a first network 40, and a LAN port X that is an interface to a second network 41. In this embodiment example, the process set includes a process of automatically setting up an IP address of the LAN port X. Hence, the network processor 130 includes an automatic IP setter 131.

The automatic IP setter 131 is configured to automatically set up an address set employable at the printer 10, in correspondence to an address set as set up at the RIP unit 20. Further, the automatic IP setter 131 is adapted, when the printer 10 is powered on after a connection once made with the RIP unit 20, to automatically start up the RIP unit 20 in concert therewith. For the automatic startup of RIP unit 20 in concert with a startup of printer 10, there is employed an existing technique WOL (Wake On LAN). The WOL outputs a WOL signal containing a MAC (media access control) address of networked target equipment, to thereby make an automatic startup of the target equipment.

Hence, the automatic IP setter 131 includes a connection setup storer 132, an IP setup storer 133, a MAC address storer 134, and an address set storer 135. Each storer may be provided with a nonvolatile memory.

The address set storer 135 is similar to the address set storer 122 in the first embodiment example. The connection setup storer 132 is configured to store in memory a piece of information on whether the RIP unit 20 is connected, that has an initial value “unconnected”. This connection setup will be updated to “connected” by the automatic IP setter 131, to be kept as it is, when and even once the connection with the RIP unit 20 is established in a later-described manner.

The IP setup storer 133 is configured to store in memory an address set employed in a previous connection with the RIP unit 20. The MAC address storer 134 is configured to store in memory a MAC address acquired from the RIP unit 20 upon an established connection therewith.

The RIP unit 20 includes an RIP 210 as software, a network processor 220, and a WOL processor 230. The network processor 220 as well as the RIP 210 is similar to that of the first embodiment example. That is, the network processor 220 includes an IP setup acceptor 221 and an address set storer 222.

The WOL processor 230 is adapted to implement, while the RIP unit 20 is powered off, a process of receiving a WOL signal containing own MAC address, responding thereto by making an automatic startup of the RIP unit 20. The WOL processor 230 has a known configuration.

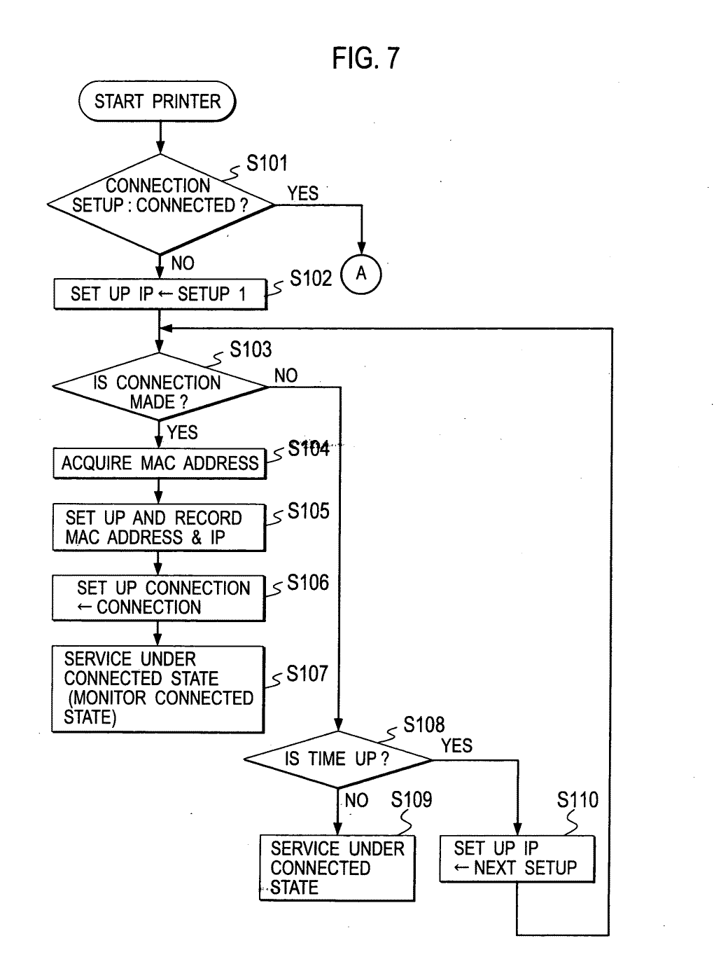

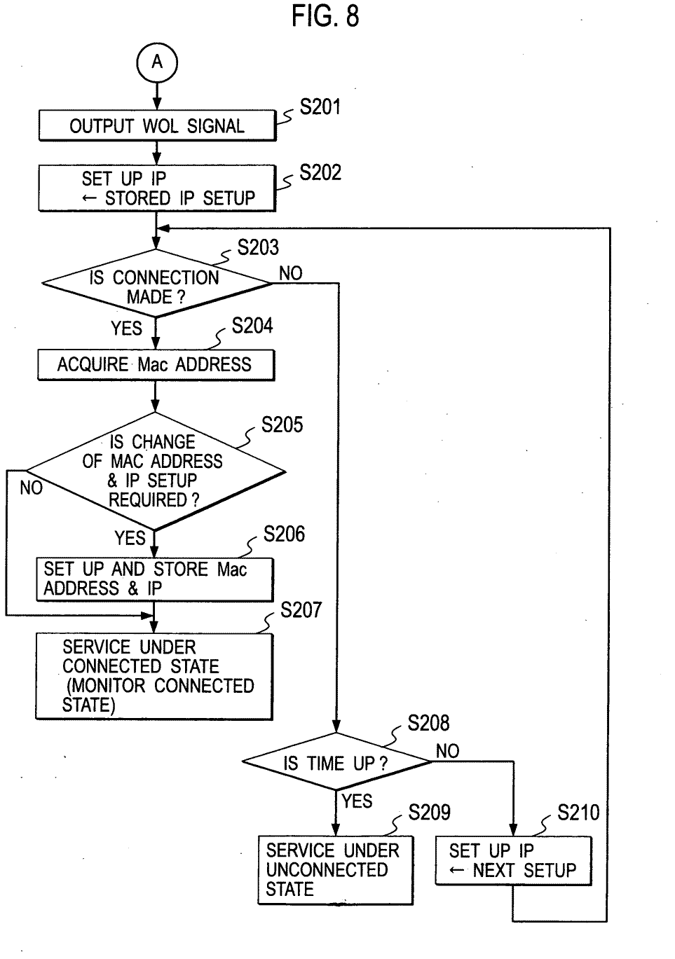

Description is now made of an automatic network setup process at the printer 10 in the second embodiment example, with reference to a flowchart shown in FIG. 7 and FIG. 8. It is assumed that, at the RIP unit 20, there has been any setup selected by network manager through the setup frame shown in FIG. 5 or such, so there is an established address set. The selection by network manager is assumed to have been one of “setup 1”, “setup 2”, and “setup 3” in conformity with criteria referred to in the first embodiment example. It is noted that the RIP unit 20 should have manually powered on for an initial connection thereof.

After a startup of the printer 10, the control flow goes to a step S101, where the automatic IP setter 131 refers to the connection setup storer 132, checking for a setup of connection with the RIP unit 20 to be “connected”.

Unless the connection setup is “connected” (No at the step S101), that is, if the RIP unit 20 has never been connected, the control flow goes to a step S102, to make a trial of connection with the RIP unit 20 using an address set of “setup 1” as a first IP address setup.

As a result, if the connection is failed (No at a step S103), the flow goes to a step S108 to determine whether or not a preset time interval has elapsed. Unless the time interval has elapsed (No at the step S108), the flow goes to a step S110, to make a trial of connection with the RIP unit 20 using an address set of “setup 2” as a second IP address setup.

Such trials of connection are sequentially repeated, in order of address sets stored by the address set storer 135. If the preset time interval has elapsed (Yes at the step S108), the flow goes to a step S109, where the printer 10 works, assuming an unconnected state of the RIP unit 20. It is noted that the connection trials are made in order of “setup 1”, “setup 2”, “setup 3”, “setup 1”, “setup 2”, . . . .

On the other hand, in success of connection with the RIP unit 20 using some address set (Yes at the step S103), the flow goes to a step S104 for acquisition of a setup of MAC address from the RIP unit 20. This MAC address is to be used every subsequent startup of printer 10, to start up the RIP unit 20 in conceit. Then, at a step S105, the address set used in successful connection is stored in memory by the IP setup storer 133, and the acquired setup of MAC address is stored in memory by the MAC address storer 134.

Next, at a step S106, the connection setup storer 132 is operated to update a record of “unconnected” to “connected”. This is because of the “unconnected” record in memory of the connection setup storer 132, with which any success in connection with the RIP unit 20 corresponds to an initial connection therewith. Then, at a step S107, the printer 10 works in a state connected with the RIP unit 20. While working, preferably, the printer 10 should be periodically monitored for a connected state with the RIP unit 20.

As a result of determination (at the step S101) as to whether the setup of connection with the RIP unit 20 is “connected” or not by collation to the connection setup storer 132 after the startup of printer 10, if the connection setup is “connected” (Yes), the flow goes to a step S201 shown in FIG. 8, where the printer 10 is operated to output from the LAN port X a WOL signal containing a MAC address stored in memory of the MAC address storer 134. The WOL processor 230 at the RIP unit 20 receives the WOL signal, responding thereto by making an automatic startup of RIP unit 20. The RIP unit 20 is thereby started in concert with the printer

There may be a mismatch of MAC address due to a replacement of the RIP unit 20 with another equipment. This will result in a failed automatic start. Therefore, after replacement of RIP unit 20, the network manager should manually power on the new RIP unit 20 to make up an initial connection.

Then, at a step S202, there is made a first trial of connection with the RIP unit 20 using an address set stored in memory of the IP setup storer 133, as an IP address setup. The address set stored in memory of the IP setup storer 133 is an address set employed in a previous success of connection, and will lead to a successful connection subject to an unchanged address set at the RIP unit 20.

If the connection is failed (No at a step S203), the flow goes to a step S208 to determine whether or not the preset time interval has elapsed. Unless the time interval has elapsed (No at the step S208), the flow goes to a step S210, to make a trial of connection with the RIP unit 20 using the next address set, as an IP address setup. It is noted that the connection trials are made in order of “setup 1”, “setup 2”, “setup 3”, “setup 1”, “setup 2”, . . . .

Such trials of connection are repeated by changing the address set in order. As a result, if the preset time interval has elapsed (Yes at the step S208), the flow goes to a step S209, where the printer 10 works, assuming a cancelled connection with the RIP unit 20 followed by a currently unconnected state, while the connection setup storer 132 is left as it has recorded “connected”.

On the other hand, in success of connection with the RIP unit 20 using some address set (Yes at the step S203), the flow goes to a step S204 for acquisition of a setup of MAC address from the RIP unit 20. Then, if the address set in success of connection is different from an address set stored in memory of the IP setup storer 133, or if the acquired MAC address is different from a MAC address stored in memory of the MAC address storer 134 (Yes at a step S205), the flow goes to a step S206 to update the content by a latest content. If the address set in success of connection is different from an address set stored in memory of the IP setup storer 133, this case corresponds to a changed address set at the RIP unit 20. If the acquired MAC address is different from a MAC address stored in memory of the MAC address storer 134, it corresponds to a replacement of RIP unit 20.

Then, at a step S207, the printer 10 works in a state connected with the RIP unit 20. While working, preferably, the printer 10 should be periodically monitored for a connected state with the RIP unit 20.

As will be seen from the foregoing description, according to the second embodiment example, the network manager can make up an interconnection between printer 10 and RIP unit 20 by simply selecting a setup of address set at the RIP unit 20. Accordingly, it is permitted in an image forming apparatus having a plurality of interfaces connected to a plurality of networks including a network connected with an image processor, to facilitate setting up connections of networks with the image processor. It also is permitted to start the RIP unit 20 in concert with the printer 10.

While the preferred embodiments of the present invention have been described using specified terms, such description is for illustrative purposes, and it is to be understood that changes and variations may be made without departing from the spirit or scope of the following claims. For instance, in the present invention, we can suppose animation data as image data to be formed.

This application is based upon the Japanese Patent Application No. 2008-277173, filed on Oct. 28, 2008, and the entire content of which is incorporated by reference herein.

What is claimed is:

1. An image forming apparatus connected to a plurality of networks including a network connected with an image processor and adapted for storage of a plurality of address sets each composed of a first kind address of the image processor and a first kind address of the image forming apparatus, the image forming apparatus comprising:
a storer configured to store in memory a plurality of address sets each composed of a first kind address of the image forming apparatus and a first kind address of the image processor, and
a communication controller configured to employ the plurality of address sets stored in memory of the storer, for a sequence of trials of connection with the image processor to determine a connectable address set to use for communications with the image processor.

2. The image forming apparatus according to claim 1, wherein
the communication controller is adapted, as a communication with the image processor is established, to acquire from the image processor a second kind address unique to the image processor to store in memory, and
the communication controller is adapted, along with a startup of the image former, to output to the image processor a WOL signal containing the second kind address as stored in memory.

3. The image forming apparatus according to claim 1, wherein
the communication controller is adapted, along with a startup of the image former, to make a sequence of trials of connection with the image processor.

4. The image forming apparatus according to claim 3, wherein
the communication controller is adapted, as a connection with the image processor is established, to store in memory information for confirmation of the connection being established with the image processor, and information for identification of a connectable address set, and
the communication controller is adapted, as the information for confirmation is stored along with a startup of the image former, to first use an address set identified by the information for identification as stored to make a trial of connection with the image processor.

5. The image forming apparatus according to claim 1, wherein
the first kind address comprises an IP address, and
the communication controller has stored in memory the plurality of address sets including an address set composed of IP addresses within a range of private IP addresses of a class A in address class, an address set composed of IP addresses within a range of private IP addresses of a class B in address class, and an address set composed of IP addresses within a range of private IP addresses of a class C in address class.

6. A print system including a combination of an image processor and an image former connected therewith through a network, the image former connected to a plurality of networks including the network, wherein
the image processor comprises:
a storer configured to store in memory a plurality of address sets each composed of a first kind address of the image processor and a first kind address of the image former, and
a setup acceptor configured to accept a selection of any address set of the plurality of address sets, and
the image former comprises:
a storer configured to store in memory a plurality of address sets each composed of a first kind address of the image former and a first kind address of the image processor; and
a communication controller configured to employ the plurality of address sets stored in memory of the storer of the image former, for a sequence of trials of connection with the image processor to determine a connectable address set to use for communications with the image processor.

7. The print system according to claim 6, wherein
the image processor comprises a WOL processor adapted, as the image processor is powered off, to receive a WOL signal containing a second kind address unique to the image processor, responding thereto by making an automatic startup of the image processor, and
the communication controller of the image former is adapted, as a connection with the image processor is established, to acquire from the image processor the second kind address to store in memory, and along with a startup of the image former, to output to the image processor the WOL signal containing the second kind address as stored in memory.

8. The print system according to claim 6, wherein
the first kind address comprises an IP address, and
the image processor has stored therein a set of address sets including an address set composed of IP addresses within a range of private IP addresses of a class A in address class, an address set composed of IP addresses within a range of private IP addresses of a class B in address class, and an address set composed of IP addresses within a range of private IP addresses of a class C in address class.
